(19) United States
(12) Patent Application Publication
(10) Pub. No.: US 2023/0145719 A1
(43) Pub. Date: May 11, 2023

(54) INORGANIC RADIATION-HARD NEUTRON SHIELDING PANELS

(71) Applicant: Jefferson Science Associates, LLC, Newport News, VA (US)

(72) Inventor: PAUL DANIEL BRINDZA, NEWPORT NEWS, VA (US)

(21) Appl. No.: 17/769,661

(22) PCT Filed: Dec. 17, 2019
(86) PCT No.: PCT/US2019/066837

§ 371 Date: Apr. 15, 2022

Related U.S. Application Data
(60) Provisional application No. 62/923,129, filed on Oct. 18, 2019.

(51) Int. Cl. G21F 1/12; G21F 1/04; C04B 28/04

(52) U.S. Cl. CPC G21F 1/12; G21F 1/042; C04B 28/04; C04B 2111/00862

(57) ABSTRACT

A self-supporting inorganic and radiation-hard neutron shielding panel for use in absorbing thermal neutrons. The panel is constructed substantially of concrete and includes a high level of boron by weight to enhance the absorption of thermal neutrons. A layer of radiation-resistant fiber reinforcement within the panel enables production of a thin, strong panel that is self-supporting and easily transportable. Mounting means are included on the panel to facilitate easy mounting on a wall or similar surface. The panels are constructed entirely of inorganic materials and include at least 58% boron by weight to maximize their effectiveness in shielding against thermal neutrons. Further disclosed are methods for forming the neutron-shielding panels.

### FIELD OF THE INVENTION

The present invention relates to the protection of people and facilities from radiation, and more specifically to a neutron shielding panel that is self-supporting, constructed entirely of inorganic materials, and incorporates a high percentage of the element boron for shielding against thermal neutrons.

### BACKGROUND OF THE INVENTION

Neutron radiation may be generated as a result of a variety of nuclear reactions or interactions. The neutrons may be generated in various facilities, including neutron sources (SNS, ESS, NIST), nuclear and particle experiments, beam therapy facilities, particle accelerators, and nuclear reactors. The neutrons generated are typically fast neutrons, having a kinetic energy level of approximately 0.1 MeV or greater, and a speed of 14,000 km's, or higher, however a portion of the emitted neutrons may be classified as thermal neutrons, or neutrons having an energy range of 1-10 eV. As these neutrons are ionizing radiation, there is a common need in all such facilities to shield equipment or people from the thermal neutrons.

Neutrons, including thermal neutrons, have a deleterious effect on both living matter and inanimate objects. Thermal neutrons may also participate in neutron activation thereby inducing radioactivity in equipment, structures, and environmental materials. It is of vital importance, therefore, to provide adequate shielding from any sources of thermal neutron radiation.

Although various methods and devices are known to be capable of providing shielding from thermal neutrons radiation, many of the shielding methods include organic materials. One such method proposes a neutron shield composed of resin-based concrete. Unfortunately, the resin component is organic and quickly degrades in a radiation environment, thereby requiring frequent replacement.

Accordingly, there is a need for neutron shielding materials that are capable of providing an effective shield for a substantial period of time. Additionally, the neutron shielding materials should be transportable, self-supporting, and constructed entirely of inorganic materials.

### OBJECT OF THE INVENTION

It is an object of the invention to provide neutron shielding materials that are self-supporting, easily transportable, constructed entirely of inorganic materials, and have a substantial service life in a thermal neutron environment.

It is a further object to provide a method of making the self-supporting materials to be used as an effective but low cost thermal neutron shield.

### SUMMARY OF THE INVENTION

The present invention describes a self-supporting inorganic and radiation-hard neutron shielding panel for use in absorbing thermal neutrons. The panel is constructed substantially of concrete and includes a high level of boron by weight to enhance absorption of thermal neutrons. A layer of inorganic fiber reinforcement within the panel enables production of thin, strong panels that are self-supporting and easily transportable. Mounting means are included on the panel to facilitate easy mounting on a wall or similar surface. The panels are constructed entirely of inorganic materials and include at least 58% boron by weight to maximize their effectiveness in shielding against thermal neutrons. Further disclosed are methods for forming the neutron-shielding panels.

### BRIEF DESCRIPTION OF THE SEVERAL VIEWS OF THE DRAWING(S)

Reference is made herein to the accompanying drawings, which are not necessarily drawn to scale, and wherein:

FIG. 1 is a front elevation view of an inorganic radiation-hard neutron shielding panel according to the invention.

FIG. 2 is a side view of the inorganic radiation-hard neutron shielding panel.

FIG. 3 is a perspective view of the inorganic radiation-hard neutron shielding panel.

FIG. 4 is a sectional view of the inorganic radiation-hard neutron shielding panel taken along line 4-4 of FIG. 2.

### DETAILED DESCRIPTION

The present invention is a self-supporting, radiation-hard neutron shielding panel and a method for its production. The shielding panel is constructed entirely of inorganic materials to maximize its service life for capturing thermal neutrons. The self-supporting panel is preferably constructed of concrete having a high level of elemental boron and glass fibers. Most preferably the boron content by weight in the panel is at least 58%. Preferably, the panel is constructed to be easily transported by hand.

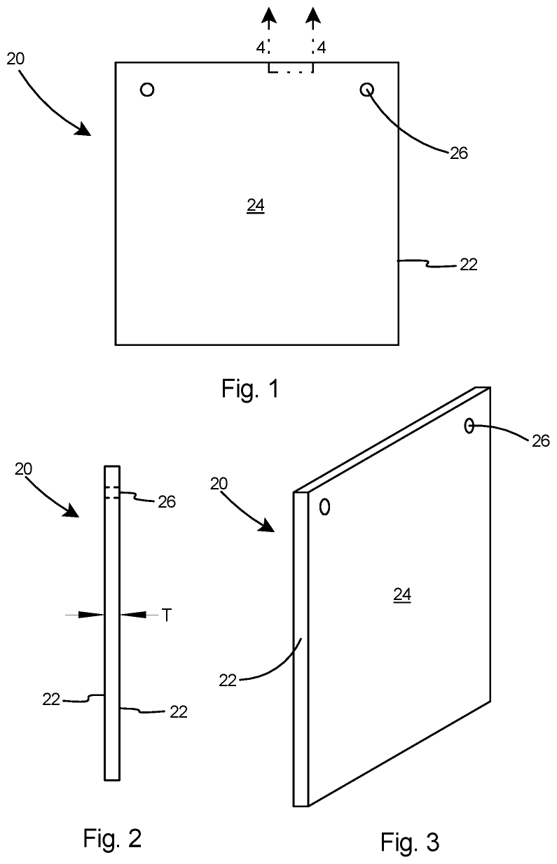

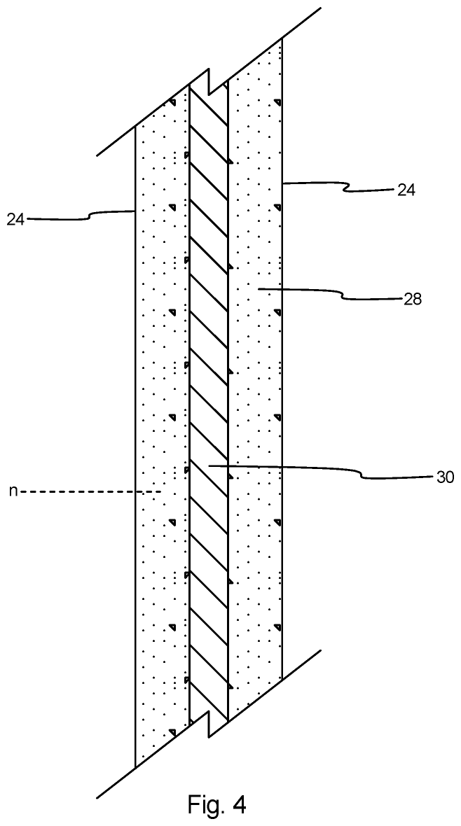

With reference to FIGS. 1-3, an exemplary neutron shielding panel 20 according to the invention includes sides 22, two opposing faces 24 having a shielding area of 30 square inches (193.5 square cm), a thickness T of 1.0 to 2.0 cm, and a weight of not more than 45 lbs. (19.6 kg), although other sizes and thicknesses are within the scope of the invention. Most preferably, the panel 20 includes a thickness T of 1.5 cm. The shielding panel may further include a mounting means including one or mounting apertures 26, most preferably two mounting apertures 26 near one of the sides 22. As shown in FIG. 4, the panel 20 preferably includes two boron-rich concrete layers 28 surrounding a glass layer 30. The two boron-rich concrete layers 28 are especially adept at absorbing thermal neutrons (n) as illustrated in FIG. 4.

The chemical element boron is evenly dispersed within the panel 20 in order to provide radiation shielding. Boron is particularly suitable for neutron shielding applications as it has one of the highest neutron absorption cross-sections of all elements. The ability of boron to effectively capture neutrons makes it ideal for applications involving thermal neutron shielding. A cost-effective method of shielding thermal neutrons can therefore be realized by constructing the self-supporting, radiation-hard neutron shielding panel of the invention with a high percentage of boron.

It is observed that the compound boron carbide (B₄C) contains seventy-six percent (76%) boron by weight and is the highest boron-containing compound known. Boron carbide is commonly used as an abrasive, in anti-ballistic materials, and in industrial applications. It is a hard granular material which can be obtained in various grit or particle sizes.

As set forth herein, boron carbide can be substituted for the sand and aggregate in a concrete mix in order to make a boron-rich concrete panel suitable for shielding thermal neutrons. The concrete/boron mixture is poured into a mold and cured to remove water and organic materials in the mix and thus molded into a boron-rich concrete panel.

Traditional concrete mixtures for construction and other such uses are well known in the art. Most, if not all, such traditional mixtures include a fine aggregate component which generally makes up a substantial portion of the concrete mixture.

The concrete mixture disclosed herein includes boron carbide in place of the fine aggregate or sand in a traditional concrete mixture. If preferred, boron carbide of two or more different particle sizes may be included in the mix in order to maximize the boron density in the finished product. If a higher density panel is desired, more than one grade of boron carbide may be used in the mixture, such as a coarse grade and a fine grade of boron carbide. In a specific embodiment, the total boron carbide by weight consists of 70 percent coarse grade and 30 percent fine grade. The coarse grade consists of particles sized between 140-145 microns and the fine grade consists of particles sized between 75-80 microns, although other particle sizes are within the scope of the invention.

Table A shows an illustrative mixture of the ingredients in a concrete mix for forming a preferred embodiment of a neutron shielding panel:

TABLE A
Concrete Mix Ingredients

| | Cubic Yard Weight | Cubic Meter Weight |
|---|---|---|
| | (the weight in | (the weight in |
| | pounds in a cubic | kilograms in a cubic |
| Ingredient | yard of mix) | meter of mix) |
| Portland Cement | 560 | 318.6 |
| Fly Ash | 100 | 56.9 |
| Boron Carbide (coarse) | 1675 | 953.0 |
| Boron Carbide (fine) | 733 | 417.0 |
| Water | 51 | 29.0 |
| plasticizer | 85.8 | 48.8 |

A method for producing a self-supporting, radiation-hard neutron shielding panel according to the invention includes:
mixing portland cement, fly ash, boron carbide, plasticizer, and water;
providing a mold of the desired shape including two projections;
pouring approximately 50% of the resultant mixture into a mold;
placing a layer of glass fabric into the mold;
pouring the remaining mix into the mold; and
curing the mixture at room temperature for at least 24 hours.

The projections within the mold form the mounting apertures in the panel. The mounting apertures facilitate the rapid installation of panels. Installation can be completed by simply driving a bolt through the apertures and into a suitable support, although the installation tool should be set to a low torque setting to avoid cracking of the panel. Conversely, bolts or similar mounting devices could be pre-installed on a wall and the panels simply hung on the mounting devices.

The volume, weight, or percentage of ingredients other than the boron carbide, such as the plasticizer, may be varied, as necessary, in order to modify the workability of the concrete or to alter any characteristics of the concrete other than the boron content. A preferred plasticizer or viscosity modifier is VISCOCRETE® 2100, which is a high range water reducing and superplasticizing ingredient that is available from Sika Corporation, Lyndhurst, N.J., although other commercial plasticizers are within the scope of the invention. The preferred fly ash is Boral Micron³™, which is available from Boral Resources of South Jordan, Utah, although other commercial sources of fly ash are within the scope of the invention. The glass fabric is preferably KAST AR 118, a 11 mm by 11 mm woven glass fabric with a “string” consisting of 8 strands having a tensile strength of 1300 to 1400 Newtons/5 cm that is available from Dr. Günther Kast GmbH & Co. of Sonthofen, Germany, although other commercial glass fabrics and glass fibers are within the scope of the invention. The 11 mm size is the spacing of the coarse weave. For production of the panel, one piece of the woven class fabric is cut to fit the mold.

It is within the scope of the invention to use a single grade of boron carbide in the mix, or to use more than one grade in order to achieve a higher density of boron carbide content, and thus a higher thermal neutron absorbing potential in the panel. Conventional dry-packed boron carbide powder is limited to approximately fifty percent (50%) of the density of the boron carbide. In comparison, the boron-rich panel is able to achieve a boron density of approximately fifty eight percent (58%) boron content by weight, compared to that of dry-packed boron carbide powder which is limited to approximately fifty percent (50%) of the density of the boron carbide.

This boron-rich concrete provides a cost-effective method of neutron radiation shielding. Concrete is a readily available and low cost building material. The boron carbide additive used herein is also relatively inexpensive. The boron-rich concrete is thus an easily prepared material that is inexpensive to apply and utilize. Further, it can be formed into any structural element or shape in the same manner as traditional concrete. The meaning of the term “boron-rich” concrete as used herein is concrete with 50% or higher by weight of boron in the cured concrete.

Potential industrial applications would include new nuclear reactor power plants, nuclear detection or fabrication facilities, buildings or rooms containing nuclear medical devices, particle beam facilities, high density shielding for nuclear propulsion systems, and any other application where the reduction of thermal nuclear radiation must be accomplished. The fact that the shielding can be actually integrated into the building structure serves to reduce overall costs and the necessary footprint of adequate levels of shielding.

Although the invention has been explained in relation to its preferred embodiments as mentioned above, it is to be understood that many other possible modifications and variations can be made without departing from the scope of the present invention. It is, therefore, contemplated that the appended claims will cover such modifications and variations that fall within the true scope of the invention.

1. An inorganic neutron shielding panel comprising:
one or more boron-rich concrete layers;
the boron-rich concrete including at least 50 percent elemental boron by weight; and
glass fibers embedded within the boron-rich concrete.

2. The inorganic neutron shielding panel in accordance with claim 1, wherein the boron is evenly dispersed within the concrete layers.

3. The inorganic neutron shielding panel in accordance with claim 1, wherein the glass fibers are a layer of woven glass fabric embedded within the concrete.

4. The inorganic neutron shielding panel in accordance with claim 1, further comprising mounting means on the panel.

5. The inorganic neutron shielding panel in accordance with claim 4, wherein the mounting means include one or more mounting apertures on the panel.

6. The inorganic neutron shielding panel in accordance with claim 5, wherein the mounting apertures extend through the one or more concrete layers and through the glass fibers.

7. The inorganic neutron shielding panel in accordance with claim 1, wherein the panel includes a thickness of at least 1.0 cm.

8. The inorganic neutron shielding panel in accordance with claim 1, wherein the panel includes a thickness 1.0 to 2.0 cm

9. The inorganic neutron shielding panel in accordance with claim 3, wherein the woven glass fabric has a tensile strength of 1300 to 1400 Newtons per 5 cm.

10. The inorganic neutron shielding panel in accordance with claim 1, wherein the panel is constructed by:
mixing portland cement, fly ash, boron carbide, plasticizer, and water to provide a boron-rich concrete mix;
providing a mold having one or more projections;
pouring approximately 50% of the boron-rich concrete mix into the mold;
placing a layer of glass fabric into the mold;
pouring the remaining mix into the mold; and
curing the mixture at room temperature for at least 24 hours.

11. A method for producing an inorganic neutron shielding panel, comprising:
mixing portland cement, fly ash, boron carbide, plasticizer, and water;
providing a mold of the desired shape including one or more projections;
pouring approximately 50% of the resultant mixture into a mold;
placing a layer of glass fabric into the mold;
pouring the remaining mix into the mold; and
curing the mixture at room temperature for at least 24 hours.
